(19) United States
(12) Patent Application Publication
(10) Pub. No.: US 2002/0182975 A1
(43) Pub. Date: Dec. 5, 2002

(54) Sports demonstration figure

(76) Inventor: Christopher Schaffer, Los Angeles, CA (US)

Correspondence Address: Richard W. Goldstein, 2071 Clove Road, Staten Island, NY, 10304, US

(21) Appl. No.: 09/866,945

(22) Filed: May 29, 2001

(51) Int. Cl. A63H 3/14; A63H 17/00; G09B 19/00

(52) U.S. Cl. 446/327; 446/330; 446/376; 446/279; 434/256

(57) ABSTRACT

A sports demonstration figure including a body portion comprised of a leg portion, a torso portion, a pair of arm portions, and a head portion. The leg portion has a pair of apertures therein dimensioned for receiving two fingers therein. The leg portion has a pair of openings disposed on lower ends thereof.

### BACKGROUND OF THE INVENTION

The present invention relates to a sports demonstration figure and more particularly pertains to allowing maneuvers and tricks performed during sporting activities to be easily demonstrated.

The use of puppets and the like is known in the prior art. More specifically, puppets and the like heretofore devised and utilized for the purpose of performing to provide amusement are known to consist basically of familiar, expected and obvious structural configurations, notwithstanding the myriad of designs encompassed by the crowded prior art which have been developed for the fulfillment of countless objectives and requirements.

While these devices fulfill their respective, particular objective and requirements, these patents do not describe a sports demonstration figure for allowing maneuvers and tricks performed during sporting activities to be easily demonstrated.

In this respect, the sports demonstration figure according to the present invention substantially departs from the conventional concepts and designs of the prior art, and in doing so provides an apparatus primarily developed for the purpose of allowing maneuvers and tricks performed during sporting activities to be easily demonstrated.

Therefore, it can be appreciated that there exists a continuing need for a new and improved sports demonstration figure which can be used for allowing maneuvers and tricks performed during sporting activities to be easily demonstrated. In this regard, the present invention substantially fulfills this need.

### SUMMARY OF THE INVENTION

In the view of the foregoing disadvantages inherent in the known types of puppets and the like now present in the prior art, the present invention provides an improved sports demonstration figure. As such, the general purpose of the present invention, which will be described subsequently in greater detail, is to provide a new and improved sports demonstration figure which has all the advantages of the prior art and none of the disadvantages.

To attain this, the present invention essentially comprises a body portion comprised of a leg portion, a torso portion, a pair of arm portions, and a head portion. The pair of arm portions each include upper and lower segments pivotally coupled. The upper segments are pivotally coupled with the torso portion. The head portion is rotatably coupled with the torso portion. The leg portion has a pair of apertures therein dimensioned for receiving two fingers therein.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved sports demonstration figure which has all the advantages of the prior art puppets and the like and none of the disadvantages.

It is another object of the present invention to provide a new and improved sports demonstration figure which may be easily and efficiently manufactured and marketed.

It is a further object of the present invention to provide a new and improved sports demonstration figure which is of durable and reliable construction.

An even further object of the present invention is to provide a new and improved sports demonstration figure which is susceptible of a low cost of manufacture with regard to both materials and labor, and which accordingly is then susceptible of low prices of sale to the consuming public, thereby making such a sport demonstration figure economically available to the buying public.

Even still another object of the present invention is to provide a new and improved sports demonstration figure for allowing maneuvers and tricks performed during sporting activities to be easily demonstrated.

Lastly, it is an object of the present invention to provide a new and improved sports demonstration figure including a body portion comprised of a leg portion, a torso portion, a pair of arm portions, and a head portion. The leg portion has a pair of apertures therein dimensioned for receiving two fingers therein.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front view of the preferred embodiment of the sports demonstration figure constructed in accordance with the principles of the present invention.

FIG. 2 is a front view of the present invention illustrated in use.

FIG. 3 is a side view of the present invention illustrated in use.

The same reference numerals refer to the same parts through the various figures.

### DESCRIPTION OF THE PREFERRED EMBODIMENT

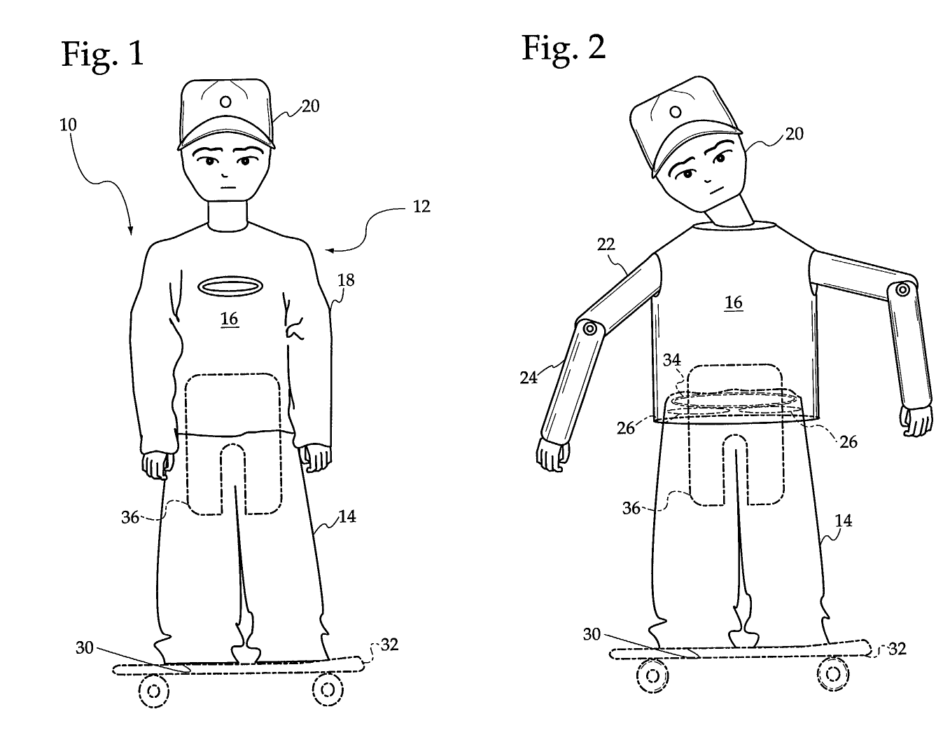

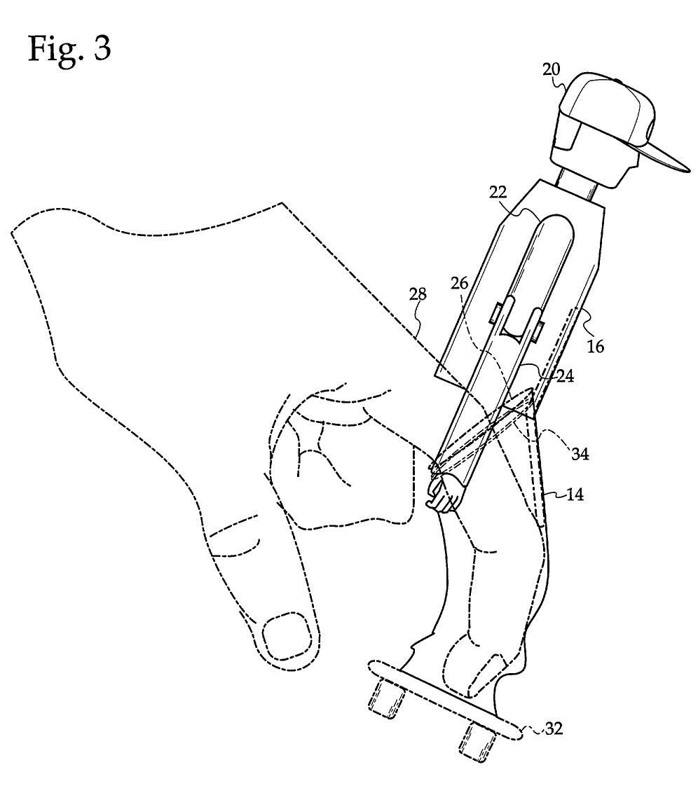

With reference now to the drawings, and in particular, to FIGS. 1 through 3 thereof, the preferred embodiment of the new and improved sports demonstration figure embodying the principles and concepts of the present invention and generally designated by the reference number 10 will be described.

Specifically, it will be noted in the various figures that the device relates to a sports demonstration figure for allowing maneuvers and tricks performed during sporting activities, such as skateboarding, roller blading, or motorcycle riding, to be easily demonstrated. In its broadest context, the device consists of a body portion having various pivotal components. Such components are individually configured and correlated with respect to each other so as to attain the desired objective.

The body portion 12 is comprised of a leg portion 14, a torso portion 16, a pair of arm portions 18, and a head portion 20. The pair of arm portions 18 each include upper and lower segments 22,24 pivotally coupled, as illustrated in FIG. 2. The upper segments 22 are pivotally coupled with the torso portion 16. The head portion 20 is rotatably coupled with the torso portion 16.

The leg portion 14 has a pair of apertures 26 where said leg portion 16 meets the torso portion 16, therein dimensioned for receiving two fingers 28 therein. A rigid ring 34 is situated at a point where the leg portion 18 meets the torso portion 16. This ring 34 serves to maintain the body portion 12 in an upright portion. Further, a plate 36 is positioned along the body portion 12 and top of the leg portion 18. The leg portion 18 has a pair of openings 30 disposed on lower ends thereof. The leg portion 18 is constructed from a stretchable conformable fabric, such as a fabric sold under the trademark Spandex ® material, in order to allow the fabric to conform to the fingers disposed therein.

A wheeled or sliding instrument 32 may be coupled with respect to the leg portion 14 of the body portion 12. FIGS. 1 through 3 illustrate the use of a skateboard as the wheeled instrument 32. It should be noted that other wheeled instruments could be used in place of the skateboard, such as roller blades, bicycles, snow boards, or motorcycles.

In use, a person simply positions his or her fingers 28 within the pair of apertures 26 to allow the body portion 12 to be maneuvered in a manner similar to a finger puppet. The fingers 28 are positioned within the leg portions 14 so that the fingers extend to the bottom openings 30 of said leg portions 14 and the entire finger is within the apertures 26. The person will be able to demonstrate specific moves that are normally performed on the wheeled instruments 32.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by letters patent of the united states is as follows:

1. A sports demonstration figure for allowing maneuvers and tricks performed during sporting activities to be easily demonstrated comprising, in combination:
a body portion comprised of a leg portion, a torso portion, a pair of arm portions, and a head portion, the pair of arm portions including upper and lower segments pivotally coupled, the upper segments being pivotally coupled with the torso portion, the head portion being rotatably coupled with the torso portion, the leg portion, constructed from a stretchable conformable fabric, having a pair of apertures therein dimensioned for receiving two fingers therein, the leg portion having a pair of openings disposed on lower ends thereof;
a rigid ring situated at a point where the leg portion meets the torso portion, said ring serving to maintain the body portion in an upright portion; and
a plate positioned vertically along the body portion and top of the leg portion.

2. A sports demonstration figure for allowing maneuvers and tricks performed during sporting activities to be easily demonstrated comprising, in combination:
a body portion comprised of a leg portion, a torso portion, a pair of arm portions, and a head portion, the leg portion having a pair of apertures therein dimensioned for receiving two fingers therein; and

3. The sports demonstration figure as set forth in claim 2, wherein the pair of arm portions each include upper and lower segments pivotally coupled, the upper segments being pivotally coupled with the torso portion.

4. The sports demonstration figure as set forth in claim 2, wherein the head portion is rotatably coupled with the torso portion.

5. The sports demonstration figure as set forth in claim 2, wherein the leg portion has a pair of opening disposed on lower ends thereof.

6. The sports demonstration figure as set forth in claim 5, wherein the leg portion is constructed from a stretchable conformable fabric, said fabric conforming to the fingers disposed therein.

7. The sports demonstration figure as set forth in claim 2, wherein a rigid ring is situated at a point where the leg portion meets the torso portion, said ring maintaining the body portion in an upright portion.

8. The sports demonstration figure as set forth in claim 2, wherein a plate is positioned vertically along the body portion and top of the leg portion.
